(19) United States
(12) Patent Application Publication
(10) Pub. No.: US 2018/0289041 A1
(43) Pub. Date: Oct. 11, 2018

(54) NATURAL DRINK

(71) Applicant: Scott Joseph, Hollywood, FL (US)

(72) Inventor: Scott Joseph, Hollywood, FL (US)

(21) Appl. No.: 15/482,847

(22) Filed: Apr. 10, 2017

(51) Int. Cl. A23L 2/02; A23L 19/00

(52) U.S. Cl. CPC A23L 2/02; A23L 19/09

(57) ABSTRACT

The present embodiments relate to a product and method for creating dietary food drinks based upon the chimpanzee's diet, which consists of nearly 100% real, raw, and whole foods. The result closely portioned food drink that are comprised of approximately 65% fruits and berries, 25% vegetables, 5% nuts, and 5% seeds by caloric intake of the total products, not including water admixture, and consisting of highly absorbable nutrients. Entire foods are often utilized, including edible peels, seeds, stems, seeds, skin, rhines, pulp, and husks pureed and blended to an enjoyable consistency. The resulting products deliver super nutrient-rich, natural meals that are closely portioned to mimic the diet of chimpanzees.

### CROSS-REFERENCE TO RELATED APPLICATION

This application claims priority to U.S. provisional patent application Ser. No. 62/148,105, filed on Apr. 15, 2015, entitled “Method for creating raw whole food drink dietary products based upon the diet of chimpanzees,” by Scott Joseph, which is herein incorporated in its entirety by reference.

### FIELD

The embodiments presented relate to a product and method for creating drink dietary drinks, and more particularly, to a product and method for creating a Real, Raw, Whole Food Drink that closely mimics the diet of Chimpanzees, based on a chimpanzee's diet that has been modified for human consumption.

### BACKGROUND

Human beings share genes with all living organisms. However, humans are members of the biological group Primates. Further, DNA analysis has confirmed that our closest living relatives are the chimpanzees and bonobos, which are also members of the Primate class. In fact, the human being and the chimpanzee have a 98.6 percent DNA match.

Although chimpanzees have migrated to a variety of habitats from their origins along the Congo River in Africa, their diets have remained virtually the same. The majority of their daily nutrition continues to be derived from fruits, leaves, buds, stems, pith, bark, and seeds. Research has shown that the diets of chimpanzees have allowed them to combat diseases, such as cancer and HIV, better than human beings.

However, there are no known drink products that provide real, raw, and whole food attributes that mimic the diet of a chimpanzee

Accordingly, there is a need for dietary drink products that are nutrient rich and closely portioned to a chimpanzee's diet, and offer more than a simple juice without the drawbacks of pasteurized drinks.

### SUMMARY OF THE INVENTION

Embodiments presented herein relate to a product and method for creating dietary drinks based upon the chimpanzee's diet, which consists of nearly 100% real, raw, and whole foods. A natural drink that generally consists of a puree of approximately 65% fruits and berries, 25% vegetables, 5% nuts, and 5% seeds by caloric intake of the total product, not including water and/or juice admixture. However, embodiments provide a drink containing at least 2% water and juice. Entire foods are often utilized, including edible peels, seeds, stems, skin, rines, pulp, and husks blended to deliver super nutrition and to make the nutrients highly absorbable in a drinkable and enjoyable consistency.

A method of producing drink dietary products based on the diet of a chimpanzee generally includes portioning and pureeing about 65% fruits and berries, about 25% vegetables, about 5% nuts and 5% seeds by caloric intake; blending the fruits, berries, vegetables, nuts, and seeds in water and/or juice along with their edible peels, skins, stems, and seeds; and creating a mixture of all ingredients. In an alternative embodiment, the fruits, berries, vegetables, nuts, and seeds may be blended and mixed in a plurality of ways for use in a variety of flavors.

The resulting products deliver super nutrient-rich, natural meals that are closely portioned to mimic the diet of chimpanzees.

A further embodiment is provided. CHIMP FOOD-RECIPE. Makes (4) 16-oz Meal Replacement Drinks

| Ingredients | (g) |
|---|---|
| Water | 717 |
| Apples | 350 |
| Banana | 61 |
| Grapes (Green) | 61 |
| Mangos | 61 |
| Pears | 61 |
| Apple Juice | 175 |
| Blackberries | 52 |
| Blueberries | 52 |
| Raspberries | 52 |
| Strawberries | 52 |
| Cranberries | 42 |
| Butternut Squash | 42 |
| Zuchinni | 42 |
| Cauliflower | 20 |
| Spinach | 4 |
| Dried Stevia Leaves | 3 |
| Almonds | 1 |
| Brazil Nuts | 1 |
| Hazelnuts | 1 |
| Macadamia Nuts | 1 |
| Pine Nuts | 1 |
| Chia Seeds | 1 |
| Flax Seeds | 1 |
| Hemp Seeds | 1 |
| Poppy Seeds | 1 |
| Pumpkin Seeds | 1 |
| Total | 1857 |

A further embodiment is provided. CHIMP FOOD-RECIPE (Orange Drink) Makes (4) 16-oz Meal Replacement Drinks

| Ingredients | (g) |
|---|---|
| Water | 623 |
| Oranges | 328 |
| Plums | 66 |
| Pears | 66 |
| Mangos | 66 |
| Banana | 66 |
| Blackberries | 55 |
| Blueberries | 55 |
| Raspberries | 55 |
| Strawberries | 55 |
| Cranberries | 43 |
| Orange Juice | 246 |
| Pumpkin | 43 |
| Yellow Squash | 43 |
| Cucumber | 43 |
| Cabbage | 4 |
| Dried Stevia Leaves | 3 |
| Almonds | 1 |
| Cashews | 1 |
| Pecans | 1 |
| Pistachios | 1 |
| Walnuts | 1 |
| Chia Seeds | 1 |
| Flax Seeds | 1 |
| Pumpkin Seeds | 1 |
| Sesame Seeds | 1 |
| Sunflower Seeds | 1 |
| Total | 1870 |

A further embodiment is provided. CHIMP FOOD-RECIPE (Grape Drink) Makes (4) 16-oz Meal Replacement Drinks

| Ingredients | (g) |
|---|---|
| Water | 803 |
| Grapes (Red) | 284 |
| Watermelon | 57 |
| Kiwi | 57 |
| Peaches | 57 |
| Grapes (Green) | 57 |
| Grape Juice | 170 |
| Blackberries | 46 |
| Blueberries | 46 |
| Raspberries | 46 |
| Strawberries | 46 |
| Cranberries | 36 |
| Butternut Squash | 36 |
| Eggplant | 36 |
| Cauiflower | 36 |
| Kale | 4 |
| Dried Stevia Leaves | 3 |
| Almonds | 1 |
| Brazil Nuts | 1 |
| Hazelnuts | 1 |
| Macadamia Nuts | 1 |
| Pine Nuts | 1 |
| Chia Seeds | 1 |
| Flax Seeds | 1 |
| Hemp Seeds | 1 |
| Poppy Seeds | 1 |
| Pumpkin Seeds | 1 |
| Total | 1830 |

A further embodiment is provided. CHIMP FOOD-RECIPE (Pineapple Drink) Makes (4) 16-oz Meal Replacement Drinks.

| Ingredients | (g) |
|---|---|
| Water | 631 |
| Pineapple | 371 |
| Plums | 74 |
| Kiwi | 74 |
| Peaches | 74 |
| Watermelon | 74 |
| Pineapple Juice | 211 |
| Blackberries | 62 |
| Blueberries | 62 |
| Raspberries | 62 |
| Strawberries | 62 |
| Cranberries | 49 |
| Pumpkin | 49 |
| Broccoli | 32 |
| Yellow Squash | 12 |
| Romaine Lettuce | 5 |
| Dried Stevia Leaves | 4 |
| Almonds | 1.20 |
| Cashews | 1.20 |
| Pecans | 1.20 |
| Pistachios | 1.20 |
| Walnuts | 1.20 |
| Chia Seeds | 1.20 |
| Flax Seeds | 1.20 |
| Pumpkin Seeds | 1.20 |
| Sesame Seeds | 1.20 |
| Sunflower Seeds | 1.20 |
| Total | 1920 |

Other aspects, advantages, and novel features of the embodiments presented will become apparent from the following detailed description in conjunction with the drawings. All such additional aspects, advantages, and novel features are intended to be included within the description and to be protected by the accompanying claims.

### BRIEF DESCRIPTION OF THE DRAWINGS

A more complete understanding of these embodiments, and the attendant advantages and features thereof, will be more readily understood by reference to the following detailed description when considered in conjunction with the accompanying drawings. The drawings described herein may not be to scale, are for illustrative purposes only of selected embodiments and not all possible implementations, and are not intended to limit the scope of the present disclosure.

FIG. 1 is a chart representing the composition by caloric intake of ingredients within the Real, Raw, Whole Food Drink that closely mimics the diet of Chimpanzees; and

FIG. 2 is a chart that shows nutritional values of the Real, Raw, Whole Food Drink that closely mimics the diet of Chimpanzees.

Corresponding reference numerals indicate corresponding parts throughout the drawings.

### DETAILED DESCRIPTION

The specific details of the single embodiment or variety of embodiments described herein are set forth in this application. Any specific details of the embodiments are used for demonstration purposes only and no unnecessary limitations or inferences are to be understood therefrom. In some example embodiments, well-known processes and well-known technologies are not described in detail.

The terminology used herein is for the purpose of describing particular example embodiments only and is not intended to be limiting. In particular, “berry” and “fruit” may at times be used interchangeably, although berries are a subset of fruit. “Nuts” are listed separately from “seeds,” although nuts may be seeds. Also, the term “seeds” is used in two senses; first, to denote the seeds that may come from a wide variety of plants and that are incorporated in these embodiments as seeds only, and second, to refer to the seeds that are part of other ingredients (such as the fruits) in these embodiments.

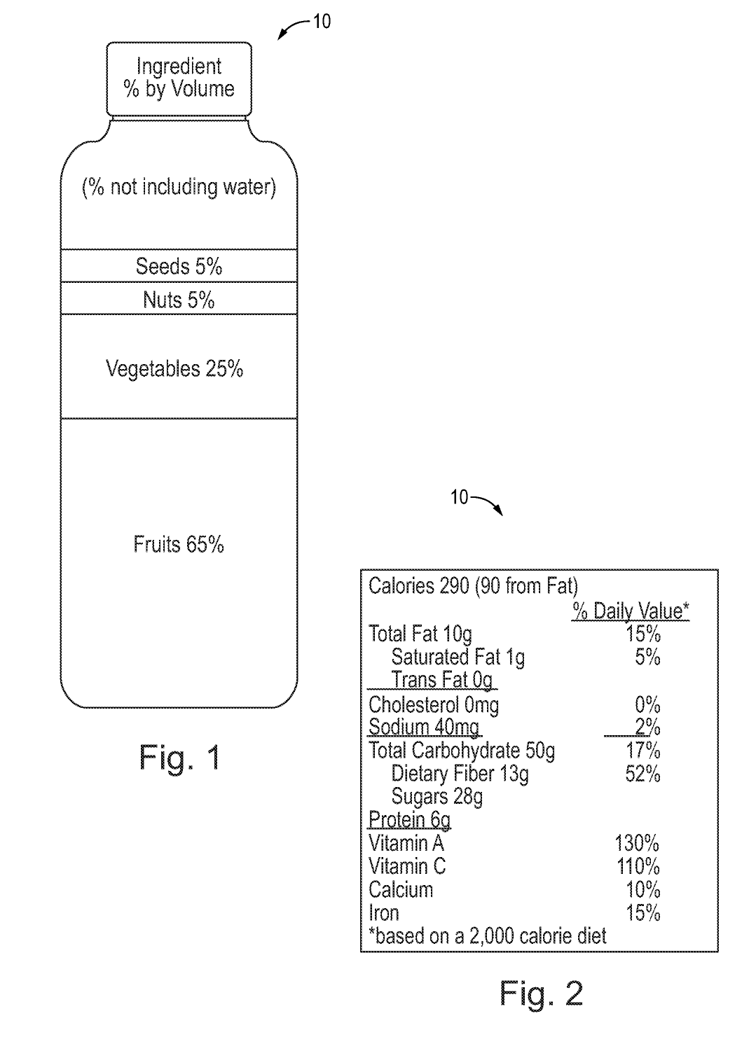

Referring now to the drawings wherein like numerals indicate like reference elements, shown in FIG. 1 is the composition by caloric intake of a natural drink 10 prior to the addition of water or juice to make the drink 10 smoother. The current embodiments may contain 65% fruits and berries, 25% vegetables, 5% nuts, and 5% seeds, all of which are pureed in their raw form, including their edible peels, skins, stems, and seeds. “Edible” is broadly defined to incorporate plant matter that is nonpoisonous, nutritious, and able to be swallowed when pureed and blended. For example, an apple core is edible when it and its seeds are pureed and blended as part of the current embodiment. In a similar way, a banana peel is edible. A liquid admixture like potable water and/or juice may be blended with the raw puree in order to bring the drink 10 to an appealing consistency for consumers. Juice adds additional flavoring.

Stevia may be added as a flavoring agent and natural sweetener, but the flavoring agent or natural sweetener is not limited to stevia. Stevia may be sourced as an extract, powder, or other derivative, or fresh or dried leaves. In a preferred embodiment, a drink 10 incorporates dried stevia leaves, which are sweeter than fresh leaves. Stevia may also count as a vegetable.

Alternatively, drink products may be combined with other ingredients such as super fruits, cacao, cinnamon flavoring, etc., to provide color and flavor characteristics familiar to consumers. Another popular ingredient with numerous nutritional benefits may be at least one tea selected from the group consisting of tea leaves, tea flavonoids, tea catechins, and tea polyphenols.

Just as the specific foods consumed by chimpanzees vary according to their habitat, yet their basic diet remains similar across habitats, different combinations of ingredients may lead to similar results for drink 10 for human consumption. It is envisioned that the current embodiment may contain a plurality of fruits, a plurality of vegetables, a plurality of nuts, and a plurality of seeds. However, a combination including only one or two of a particular food group may bring a similar result. Likewise, the percent of caloric intake for a particular food group may vary within a range and bring a similar result. For example, a raw puree may comprise at least 55-65% consisting of fruits, at least 20-30% consisting of vegetables, at least 5-15% consisting of nuts, and at least 2-8% consisting of seeds. The raw puree may include at least one peel or skin, at least one stem, and at least one fruit seed, for example.

The present invention is a nearly “100% real,” raw, uncooked whole food drink 10 that is thicker than a typical juice. The current serving size is one 16 fluid ounce bottle (473 mL), and a consumer may drink a serving in place of a meal—breakfast, lunch, or dinner. Drinking these nutrient-dense servings may closely provide a full day's supply of foods a human body needs.

Pureeing and blending allow the nutrients to be more fully absorbed. The distinction between blending and juicing is important. Juicing removes the fiber and produces sugary water, but blending allows a person to consume the entire food, including the pulp. The pulp is fiber that keeps the digestive tract healthy and slows down the absorption of sugar. Plant-based carbohydrates can regulate blood sugar levels, lower cholesterol, and leave a person feeling fuller longer.

Natural state fruits, vegetables, nuts, and seeds, are rich in vitamins, minerals, and enzymes. Enzymes act as a natural digestive aid. As with most “living” foods, the closer the food remains to its natural state, the greater the nutritional benefits when consumed. Consuming raw maximizes the nutritional value versus cooking or pasteurizing.

FIG. 2 describes the current embodiments of a Real, Raw, Whole Food Drink that closely mimics the diet of Chimpanzees, 10 regarding its nutritional value.

### Example 1

An example of a food drink 10 that contains about twenty-five different vegetables, berries, other fruits, nuts, and seeds is an Apple blend with the following ingredients: apples, apricots, mangos, kiwi, pears, blackberries, blueberries, cranberries, raspberries, strawberries, Brussels sprouts, carrots, eggplant, romaine lettuce, sweet potatoes, almonds, cashews, pecans, pistachios, walnuts, chia seeds, flax seeds, pumpkin seeds, sunflower seeds, sesame seeds, water, apple juice, and stevia leaves. Edible peels, skins, seeds, and stems are included.

### Example 2

A second example of a food drink 10 that contains about twenty-five different vegetables, berries, other fruits, nuts, and seeds is an Orange blend with the following ingredients: oranges, apples, bananas, cherries, peaches, blackberries, blueberries, cranberries, raspberries, strawberries, arugula, broccoli, carrots, spinach, sweet potatoes, almonds, cashews, pecans, pistachios, walnuts, chia seeds, flax seeds, pumpkin seeds, sunflower seeds, sesame seeds, water, orange juice, and stevia leaves. Edible peels, skins, seeds, and stems are included.

### Example 3

A third example of a food drink 10 that contains about twenty-five different vegetables, berries, other fruits, nuts, and seeds is a Pineapple blend with the following ingredients: pineapple, bananas, kiwi, mangos, watermelon, blackberries, blueberries, cranberries, raspberries, strawberries, asparagus, butternut squash, kale, pumpkin, spinach, almonds, Brazil nuts, hazelnuts, macadamia nuts, pine nuts, chia seeds, flax seeds, hemp seeds, poppy seeds, pumpkin seeds, water, pineapple juice, and stevia leaves. Edible peels, skins, seeds, and stems are included.

### Example 4

A fourth example of a food drink 10 that contains about twenty-five different vegetables, berries, other fruits, nuts, and seeds is a Grape blend with the following ingredients: grapes, apricots, cherries, peaches, pears, blackberries, blueberries, cranberries, raspberries, strawberries, Bibb lettuce, bok choy, butternut squash, cucumber, pumpkin, almonds, Brazil nuts, hazelnuts, macadamia nuts, pine nuts, chia seeds, flax seeds, hemp seeds, poppy seeds, pumpkin seeds, water, grape juice, and stevia leaves. Edible peels, skins, seeds, and stems are included.

Not every ingredient listed above is necessary to successfully formulate a raw, natural drink 10 based upon the diet of chimpanzees. Rather, the mixes described are representative, and each ingredient may be used independently or in combination to represent its food group if that ingredient is used at all.

The method of producing drink dietary drinks 10 based on the diet of a chimpanzee includes the following steps: (1) providing, portioning, and pureeing about 65% fruits and berries, about 25% vegetables, about 5% nuts, and about 5% seeds by caloric intake; (2) blending the fruits, berries, vegetables, nuts, and seeds in a water and/or juice admixture along with their edible peels, skins, stems, and seeds; and (3) creating a mixture of all ingredients. In an alternative embodiment, the fruits, berries, vegetables, nuts, and seeds in steps (1) and (2) may be blended and mixed in a plurality of ways for use in a variety of flavors. The individual ingredients listed above may be added in whole or part in a plurality of steps. Seen in conjunction with the above-detailed description of the Real, Raw, Whole Food Drink that closely mimics the diet of Chimpanzees, 10, this method may accommodate a range of ingredients and processes, and it is understood that the sequence of steps may change with blending and mixing technology.

It will be appreciated by persons skilled in the art that the present invention is not limited to what has been particularly shown and described hereinabove. A variety of modifications and variations are possible in light of the above teachings without departing from the following claims.

What is claimed is:

1. A dietary drink for human consumption comprising: a raw puree having a volume, before admixture of a liquid, comprising:
at least 60-70% consisting of at least two fruits;
at least 20-30% consisting of at least two vegetables;
at least 5-15% consisting of at least two nuts; and
at least 2-8% consisting of at least two seeds; wherein the volume of the raw puree includes at least one peel or skin, at least one stem, and at least one fruit seed; and
wherein the raw puree is blended to a drinkable consistency.

2. The drink of claim 1, further comprising a potable liquid admixture.

3. The drink of claim 1, wherein the raw puree has a volume comprising: 65% consisting of at least two fruits, 25% consisting of at least two vegetables, 5% consisting of at least two nuts, and 5% consisting of at least two seeds.

4. The drink of claim 1, wherein the at least two fruits, at least two vegetables, at least two nuts, and at least two seeds include their edible peels, skins, stems, and seeds.

5. The drink of claim 1, further comprising a flavoring agent.

6. The drink of claim 1, further comprising at least one tea selected from the group consisting of tea leaves, tea flavonoids, tea catechins, and tea polyphenols.

7. A dietary drink for human consumption comprising: a raw puree having a volume, before admixture of a liquid, comprising:
at least 65% consisting of at least one fruit;
at least 20% consisting of at least two vegetables;
at least 5% consisting of at least two nuts;
and at least 5% consisting of at least two seeds; wherein the raw puree is blended with water and/or juice to a drinkable consistency; and wherein the at least two fruits, at least two vegetables, at least two nuts, and at least two seeds include their edible peels, skins, stems, and seeds.

8. The drink of claim 10, wherein the raw puree remains cool within at least four hours of bring altered from a natural state.

9. The drink of claim 10, wherein the raw puree includes, independently or in combination, pineapple, bananas, kiwi, mangos, watermelon, blackberries, blueberries, cranberries, raspberries, strawberries, asparagus, butternut squash, kale, pumpkin, spinach, almonds, Brazil nuts, hazelnuts, macadamia nuts, pine nuts, chia seeds, flax seeds, hemp seeds, poppy seeds, and pumpkin seeds.

10. The drink of claim 10, wherein the raw puree includes, independently or in combination, grapes, apricots, cherries, peaches, pears, blackberries, blueberries, cranberries, raspberries, strawberries, Bibb lettuce, bok choy, butternut squash, cucumber, pumpkin, almonds, Brazil nuts, hazelnuts, macadamia nuts, pine nuts, chia seeds, flax seeds, hemp seeds, poppy seeds, and pumpkin seeds.

11. The drink of claim 17, further comprising a raw puree having a volume, before admixture of a liquid, of:
at least 55-65% consisting of at least two fruits;
at least 20-30% consisting of at least two vegetables; at least 5-15% consisting of at least two nuts; and
at least 2-8% consisting of at least two seeds; and
wherein the volume of the raw puree includes at least one peel or skin, at least one stem, and at least one fruit seed.

12. The drink of claim 18, wherein the raw puree has a volume, before admixture of a liquid, comprising: at least 65% fruits, at least 25% vegetables, at least 5% nuts, and at least 5% seeds.
